(19) United States
(12) Patent Application Publication
(10) Pub. No.: US 2014/0270479 A1
(43) Pub. Date: Sep. 18, 2014

(54) SYSTEMS AND METHODS FOR PARAMETER ESTIMATION OF IMAGES

(71) Applicant: SONY CORPORATION, Tokyo (JP)

(72) Inventors: Alexander Berestov, San Jose, CA (US); Cheng-Yi Liu, Santa Clara, CA (US)

(73) Assignee: SONY CORPORATION, Tokyo (JP)

(21) Appl. No.: 13/840,872

(22) Filed: Mar. 15, 2013

(51) Int. Cl. G06T 7/00

(52) U.S. Cl. CPC G06T 7/0061; G06T 7/0085
USPC 382/154

(57) ABSTRACT

Systems and methods are disclosed for identifying the vanishing point, vanishing direction and road width of an image using scene identification algorithms and a new edge-scoring technique.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to 3D computational geometry/graphics. Specifically, the invention provides a method of image characterization, and more particularly to detecting vanishing points, vanishing direction and road width in a 2D image.

2. Description of Related Art

Due to the large variances between images, it is hard to identify all the parameters for every image, even by human beings. Typically, the vanishing point is defined as the perspective projections of any set of parallel lines that are not parallel to the projection plane. Various methods have been proposed for vanishing point determination, such as, those involving a support vector machine (SVM) algorithm, but owing to the complexity of training images on a neural network, such methods becomes computationally costly. Further, some algorithms are based on Random Sample Consensus (RANSAC) to determine the vanishing point. A RANSAC algorithm finds the best subsets of edges or supporting edges where all the supporting edges finally converge at a vanishing point. The weakness of the RANSAC method is that if more than one vanishing points are to be determined, the number of iterations to detect a vanishing point increases.

### BRIEF SUMMARY OF THE INVENTION

An aspect of the present invention is a 3D computational graphical model that uses an edge scoring algorithm. The method of the present invention involves scoring each edge of an image via several properties such as, the edge length, the possibility it belongs to the vertical/horizontal plane boundaries, and the probability it supports a VP with other edges. The method of the present invention is computationally very cheap and effective in terms of determining vanishing point, vanishing direction and width of a road in a 2D image.

In one embodiment, a vanishing point can be detected by computing a set of parameters from the 2D image, and the angle corresponding to the vanishing point.

One aspect of the present invention is a method for detecting vanishing points, vanishing direction and road width in an input 2D image by identifying whether or not the input image comprises regular patterns and usable edges for vanishing point analysis. Preferably, scene identification of reliable images is performed with a rule-based method without use of training data. In one embodiment, identification of reliable images is based on the entropy of the histogram of oriented gradients (HoG) and the ratio of short edges. In one embodiment, identification of reliable images may be used for detection of man-made scenes or regular patterns.

In one embodiment, the vanishing point can be detected by computing a set of parameters from the 2D image, and the angle corresponding to the vanishing point.

Another aspect is a method for detecting the vanishing point from input images by utilizing an edge scoring method, wherein the edge scoring method includes determining a set of edges that occur a maximum number of times in the direction of the vanishing point.

In one embodiment, the edges are scored according to several properties such as, the edge length, the possibility it belongs to the vertical/horizontal plane boundaries, and the probability it supports a VP with other edges. In one embodiment, the edge score is computed using a calculated histogram of oriented gradients (HoG).

In one embodiment, the detected VP is used for computing a depth map, calibrating the direction of a camera, or classifying the different planes in the image.

Another aspect is a method to estimate computer graphic model (CGM) parameters from a single 2D Image, including the vanishing point, the vanishing direction, and the width of the ground plane. The method comprises three primary parts, 1) fast scene identification to identify if the composition of an image is appropriate for vanishing point analysis, 2) vanishing point detection based on a novel edge-scoring method, and (3) vanishing direction and road width estimation (VDE/RWE) based on a plane classification method.

To accelerate the computation of the three parts, the methods of each component were configured not only to improve the performance itself, but to facilitate the computation of other components. The three primary components are configured to execute as a whole, or have the flexibility to execute independently for purposes other than CGM.

Another aspect of the present invention is estimation of the ground plane in an image without façade analysis. In one embodiment, estimation of the ground plane is performed via a segment-based method. In another embodiment, the analysis of the supporting edges of detected vanishing points is used to obtain a small number of plane boundary candidates. The method comprises a semi-supervised analysis (no training models) to identify plane boundaries with each plane initialized by a few segments only.

A further aspect is a method for estimating the vanishing direction from center of the straight road to the vanishing point. Another aspect is a method for estimating the road width of the straight road based on a plane identification method. In one embodiment, the vanishing direction and road width are estimated using two lines originated from the vanishing point and spanning the ground plane. Preferably, the two lines are computed in constant time.

The calculated vanishing direction and road width may be used for image-based guiding or surveillance systems.

In one embodiment, a set of parameters comprising four scalars are calculated to generate an ellipsoid CGM for 3-D walkthrough simulation.

The systems and methods of the present invention can be integrated with software executable on computation devices such as computers, cameras, video recorders, mobile phones, or media players to quickly generate 3D environments from 2D scenes. The systems and methods may be used for computer graphics production, movie production, gaming, VR touring, digital album viewers. With use in conjunction with GPS data, the systems and methods may be used with image-based guidance systems such as vehicle auto-guidance or mobile robots.

In a preferred embodiment, the VP detection method is used with an image-capturing device such as a camera.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 illustrates a high-level flow diagram of a method for parameter estimation of a 2D image.

FIG. 2 shows schematic diagram showing particular relationships between modules of the system of the present invention.

FIG. 3 shows a schematic diagram of the scene identification module of the present invention.

FIG. 4 shows a detailed flow diagram of the HoG step of FIG. 3.

FIG. 5 graphically illustrates the division step and histogram calculation step of FIG. 4.

FIG. 6 illustrates an exemplary image for detection of co-occurrence directions

FIG. 7 is a schematic diagram showing the gradient directions from HoG representing the directions of intensity change.

FIG. 8A and FIG. 8B are schematic diagrams illustrating horizontal and vertical scan directions, respectively.

FIG. 9 is an image illustrating changing blocks in blue crosses that locate at the transitions of planes.

FIG. 10 shows an example of an image of a building scene with three corresponding vanishing points.

FIG. 11 is a schematic diagram defining an edge support a vanishing point.

FIG. 12 is a plot of the “Preference Matrix” for computation of J-Linkage.

FIG. 13 schematically illustrates the Jaccard distance between two clusters as the distance between the two closest data points, one from each cluster.

FIG. 14 is a flow diagram for the VP detection method of the present invention.

FIG. 15 shows the preference matrix for the K VPs (K×N′) clustering of VP's.

FIG. 16 shows an image exemplary of VP ROI in accordance with the present invention.

FIG. 17 illustrates the four-plane model centered by an inside VP in accordance with the present invention.

FIG. 18 shows a series of images to illustrate the steps to calculate supporting directions in accordance with the present invention.

FIG. 19 illustrates a high-level flow diagram of the plane classification method of the present invention.

FIG. 20 shows an input image and its resultant segmentation image produced by the super-pixel segmentation method.

FIG. 21 is a schematic diagram illustrating the processing flow and the data used for the classification method of the present invention.

FIG. 22 is a representation of angle (θ) and distance (r) between the centroid of a segment and the VP.

FIG. 23 is an image exemplary of a similarity matrix in accordance with the present invention.

FIG. 24 is a diagram showing the relation between the VP, the horizon, and four supporting lines in accordance with the present invention.

FIG. 25 shows a series of images illustrating the choice of the initial supporting lines from an angular histogram.

FIG. 26 is an image illustrating initial plane setting.

FIG. 27 shows an image and the detected intersection areas of the vertical and horizontal edges of original image.

FIG. 28 is an image that illustrates possible reasons for horizontal lines.

FIG. 29 is a pair of images illustrating the maximum ground spanning lines and the minimum ground spanning lines with respect to a segmentation image.

FIG. 30A, FIG. 30B, and FIG. 30C are a series of images illustrating ground spanning lines by classified planes.

FIG. 31A and FIG. 31B are a pair of images illustrating the bisector of two ground spanning lines.

FIG. 32 is an image illustrating an estimated road width in accordance with the present invention.

FIG. 33 illustrates a method for choosing a point on a vanishing direction for road width estimation.

FIG. 34 shows an illustration of two example images for applying the calculated VD and RW to CGM in accordance with the present invention.

FIG. 35 is a flow diagram that summarizes the CGM process of the present invention.

FIG. 36 shows an image that pictorially illustrates the spanning lines of the ground plane.

FIG. 37 shows a plot of the distribution of the area bias of instances which have their VP and VDs successfully estimated.

FIG. 38 is a schematic diagram of a system for parameter estimation of a 2D image in accordance with the present invention.

### DETAILED DESCRIPTION OF THE INVENTION

FIG. 1 illustrates a high-level flow diagram of a method 10 for parameter estimation (e.g. for use in generating 3D computer graphic models) based on a 2D image.

First, at block 12, scene identification (SI) is performed to identify if the input image is comprised of some regular patterns and usable edges for later processing steps.

Next, at block 14, vanishing point detection (VPD) is performed to detect the vanishing point(s) of the image. If the VPs are detected, the estimation of other parameters such as the direction for walk-through (vanishing direction, VD) and the width of the road to walk-through (RW) can be derived accordingly.

Accordingly, at block 16 vanishing direction estimation (VDE) is performed using the detected vanishing points to estimate the direction from the center of the straight road to the vanishing point. At block 18, road width estimation (RWE) is performed to estimate the width of the straight road which has both sides attached to vertical structures.

It is appreciated that although a particular objective of the present invention is to provide VP, VD, and RW for Computer Graphic Model (CGM) parameters, the systems and methods described herein may also be used in applications other than CGM. Many of the methods in the present invention are independent from CGM.

FIG. 2 shows a schematic diagram showing particular relationships between modules of system 20 of the present invention. Fundamental modules 34 (line segment detection module 22 GL transduction module 24 and geometric context module 26) are used as inputs for task modules 36 (SI12, VPD 14, VDE 16, and RWE 18). The fundamental modules 34 can operate independently from all the others. The task modules 36 are for completing some specific tasks and utilize the fundamental modules 34. Accessory modules (e.g. tools 30) may contain some functions for displaying and evaluating the results from the task modules 36.

I. Scene Identification (SI)

Contents in images can be very different from one to another. For example, an image with many long straight lines due to man-made structures, which may help in analyze the sky, ground, and buildings, may be significantly different from an image having irregular, short edges due to both the trees and the water. Most image processing or computer vision algorithms, depending on the image clues they chose, would therefore have limitations on the type of images giving the best performance.

The vanishing point detection module 14 of the present invention is based primarily on edge or straight line information. Because a wrong result can be more detrimental than a missed detection, the scene identification module of the present invention acts to remove the images with unreliable clues, instead of searching an “all-robust” algorithm for all cases. Thus, it avoids risky images and focuses on those that are good for analyzing. The responded results can have fewer error rates and more appeal to users.

First, categories of images that are hard/easy to process are defined. As mentioned above, the use of different image clues can lead to different selections of good images, and thus it is desirable to have good images having salient edges or lines. The images with more regular edges, which are mostly caused by man-made structures such as buildings, markers, fences, or desks, are generally easier to solve. On the other hand, the edges caused by trees, snow, or water are usually less informative and time consuming to process. Accordingly, an object is to identify the scene categories of useful images and excluded the inappropriate images from further processing.

As scene identification 12 is an auxiliary task for vanishing point detection 14, the preferred method is simple and fast to save time. The two categories: one can be processed by VPD and the other cannot. Most of the accepted images (category of images that can be processed by VPD) are man-made and most of the removed ones (category of images that cannot be processed by VPD) are natural-like. Therefore, though the problem is not fully identical to man-made/natural scene identification, the terms ‘Man-made’ and “Natural” are used to denote the two categories.

FIG. 3 shows a schematic diagram of the scene identification module 12 of the present invention. First a histogram of gradients (HOG) is calculated at step 40. HoG is an informative descriptor to represent the distribution of gradient/edge directions in different regions. From the HoG 40, the ratio of natural blocks 42, ratio of short edges 44, co-occurrence directions 46, and changing blocks 48 may be derived, which are all used in selecting images with string edge information at step 50.

FIG. 4 shows a detailed flow diagram of the HoG step 40. As HoG is based on gradients, its computation is based on the intensity information (gray level) instead of color. At each location of the image, the gradient values in the vertical (g_{y}) and the horizontal (gₓ) directions are calculated at step 52 by two simple kernels: [−1, 0, 1]^{T} and [−1, 0, 1]. Next at step 54, the magnitude is obtained for each location. With gₓ and g_{y}, two measures can be obtained for each location:

Magnitude=(gₓ²+g_{y}²)^{1/2}

Orientation=atan (gₓ/g_{y})

Next, at step 56, the image is divided into blocks in the x- and the y-directions, and a histogram is calculated for each block at step 58. FIG. 5 shows division step 56 and histogram calculation step 58 in more detail. The middle image 62 of the original image 60 is divided into 2×2 blocks by the solid lines. For each block, a histogram with B bins is calculated, wherein each bin of the histogram represents an orientation and accumulates the magnitudes of the locations in this orientation. For example, the lower two histograms 66 and 68 in FIG. 5 correspond to the lower two blocks of middle image 62. Considering the B bin values of a block as a vector, we normalized the bin values by the L2-norm of the vector, so the length of the vector would be 1.0. The basic HoG descriptor is then the block by block concatenation of these histogram bin values, which is a vector in length=#blocks*#bins.

Beside the single division of blocks, one can expand this to multi-level of divisions such as 1×1, 2×2, 4×4, 8×8 . . . . This forms the so-called hierarchical HoG (H) that everything is again cascaded together:

H=[h1,h2,h2_{—}1 . . . h2_{—}4,h3_{—}1 . . . h3_{—}16 . . . ]^{T}

where h1 is the 18-bin histogram (an 18×1 vector) of the whole image 64. h2 has its number of blocks in each direction=2, with a total of four blocks indexed from h2_{—}1 to h2_{—}4, and then h3, h4 . . . . Hence, H also contains the magnitudes of orientations in different scales which can represent more informative gradient/edge distribution of the image. In a preferred method, we use the hierarchical HoG from 1×1 to 8×8 blocks.

As mentioned above, the objective module 12 is to include the images with strong/reliable edge information and remove the less informative ones from following processes. The following two measures were developed:
a) Ratios of Natural (non-regular edges) blocks at different levels of block divisions (block 42).
b) Ratio of short edges to the total number of edges (block 44).

The computation of block 42 is to check if there are sufficient blocks with dominant orientations at any HoG level. We use the four level HoG to cover the different scales of image divisions: 1×1, 2×2, 4×4, and 8×8. The orientations are defined from 0 to 180 degrees and divided into 18-bins. To check the existence of dominant orientations of a block, we compute the entropy of its HoG. For the HoG of some block i, all bin values are normalized by the sum of the 18 bin values such that it becomes a probability value between 0˜1. The HoG normalized by the L2-norm in can have the sum of bin values>1.0. The normalization here is to make the bin values become probabilities that the sum of them=1.0. We use the classic definition of entropy so E(i)=−k=118H(i,k)logH(i,k), where the kth bin of block i is H(i,k) and the entropy value is E(i). A block having its entropy value larger than Th_H1 is considered as a Natural block because it cannot show any dominant orientation. For some HoG block division level n, we further calculate the ratio of Natural blocks to the total number of blocks (P(n)). For example, if we have 3 natural blocks at level 2, and the total number of blocks of level 2 is four, we obtain P(2)=¾. Another threshold, Th_H2, is defined to make decisions on P(1),P(2),P(3),and P(4).

Unlike block 42 using HoG, block 44 only depends on the lengths of edges, and rejects the images with many irregular, short edges. Th_E1 is introduced for edge lengths, so the edges shorter than Th_E1 are defined as the short edges. This gives us a ratio R=(# short edges)/(# total edges) and a predefined Th_E2 is used to threshold R for a decision. To summarize, an image is considered as ‘Man-made’ if it satisfies both:

(1) Any of P(1),P(2),P(3),P(4)<Th_H2 so we can observe sufficient blocks with regular orientations at some scale(s); and

(2) R<Th_E2 so there are sufficient number of long (maybe reliable) edges. Otherwise, it is considered as “Natural.”

To prepare for VPD 14, more information may be derived from HoG 40, since it contains abundant spatial characteristics of an image. Instead of considering the multiple levels of block divisions in our HoG, only the fourth level of blocks, 8×8 blocks, will be used here.

Two more measures that may be derived from the calculated HoG 4^{th} level blocks are co-occurrence directions 46 and changing blocks of the image at block 48.

FIG. 6 illustrates an exemplary image 70 for detection of co-occurrence directions according to block 46. Most parts of the two solid black lines are the transition locations between the vertical walls and the ground. They are longer and salient relative to other edges. Following each of the lighter arrows can meet both directions multiple times. The objective of co-occurrence directions block 46 is to search for the pairs of directions which appear frequently among the whole image. For example, it would be helpful if we can identify the two directions of the two solid dark lines in FIG. 6, and the solid dark lines can be concurrently seen multiple times if we scan the blocks from left to right, row by row. Since HoG already showed the salient edge directions (major directions) of each block, we can check all these directions and the frequency of their co-occurrence (in a preferred implementation, the best two orientations of each block are used).

FIG. 7 is a schematic diagram showing the gradient directions from HoG representing the directions of intensity change. Edge directions are represented by rotating −90°.

FIG. 8A and FIG. 8B are schematic diagrams illustrating horizontal and vertical scan directions, respectively. Giving the best edge direction of a block, θ, two searching directions are implemented: left to right (FIG. 8A, image 72) and top to bottom (FIG. 8B, image 74). Since two paired directions are expected to form a VP, the range of the searched directions is at least δ apart from θ. Assuming θ comes from block i, for any block j right to block i, we check if a major direction of block j, φ, satisfies π>=φ>=θ+δ. The other searching direction is from top to bottom. For block j lower than i, we check according to FIG. 8A and FIG. 8B.

The found pairs of co-occurrence directions, both from left to right and top to bottom, are accumulated in a co-occurrence table. We use the same settings for HoG so that the 0˜180 degrees are quantized into 18 bins so the co-occurrence table is 18×18. For each found pair (θ, φ), φ that comes from block j, it will accumulate the table at entry (θ, φ) by the HoG bin value corresponding to φ from block j. Finally, if an entry (θ, φ) is above a threshold, we take both directions as the co-occurrence directions and will emphasize the edges in the co-occurrence directions for VPD.

The other derived information, changing blocks 48, is designed to detect the blocks containing plane transitions. FIG. 9 is an image 76 illustrating changing blocks in light crosses that locate at the transitions of planes. As shown in FIG. 9, such a transition may cause a large difference of color, texture, or edge orientations between the neighboring blocks. The difference between block i and its neighboring blocks, Diff(i), can be defined as:

Diff(i)=Σ_{block j connected to block i}Σₖ₌₁¹⁸abs(H(i,k)−H(j,k)), Eq. 1

where H(i, k) is the HoG bin value only normalized by the L2-norm so different from H(i, k).

In the method of the present invention, the difference of neighboring blocks is a bit more complicated. All HoG bins arranged such that the bins are corresponding to edge directions instead of gradient directions. The following vertical and horizontal filters are separately applied to the rearranged HoGs of 3×3 blocks where the block to check, i, locates at the center:

v_filter=[−1,−2,−1;0,0,0;1,2,1],h_filter=v_filter^{T}.

Two vectors of 18 directional differences Dₕ(I, 1 . . . 18) and Dᵥ(I, 1 . . . 18) can be obtained by applying the corresponding filters. We then summarize the 18 bins of differences to a single value D(i) by the weighted norm:

D(i)=Σₖ₌₁¹⁸((Wₕ(k)*Dₕ(i,k))²+(Wᵥ(k)*Dᵥ(i,k))²)^{1/2} Eq. 2

where Wₕ, Wᵥ are two weighting vectors corresponding to the 18 directions.

Wₕ and Wᵥ are designed to emphasize the discontinuity of edges parallel to the differential directions. For example, 0° and 180° would be emphasized after the horizontal block filtering, while 98° would be emphasized after the vertical block filtering. The current assignments of Wₕ and Wᵥ are:

$${W}_{v} ( k ) = abs ( sin ( ( \frac{k}{18} - \frac{1}{36} ) * π ) ) , \\ and \\ {W}_{h} ( k ) = abs ( cos ( ( \frac{k}{18} - \frac{1}{36} ) * π ) ) , \qquad Eq . 3$$

II. Vanishing Point Detection (VPD)

In a 2D image, one can observe that the originally parallel lines in 3D show convergence. The points where these lines converge are called the “vanishing points” (VPs). One image can have multiple vanishing points, and a vanishing point can be either inside or outside the image. FIG. 10 shows an example of an image 80 of a building scene where we can find the three corresponding vanishing points: one 84 is inside the image due to the road; another 82 is outside and left to the image; the third 86 also locates outside but infinitely above the image.

For use with CGM, the target vanishing points are those inside the 2D image, and the two sides of the road to walk-through converge to one of them.

To find the vanishing points, the key is to choose the clues (usually the edges) from an image that really relate to the VPs. The most popular existing method is to use the “RANdom SAmple Consensus” (RANSAC) algorithm for finding the best subset of edges supporting the best VP. We call the subset of edges the “supporting edges” for this VP because all the extension lines from these edges can converge to this VP; on the contrary, other edges in the image are called the “outliers.” If multiple VPs are expected, one can keep feeding the outliers respective to the found VP(s) to RANSAC for finding more VPs. Hence, one needs to set the number of VPs, i.e., the maximum iterations to run RANSAC. Another popular method is to use “Expectation-Maximization” (EM) for grouping the edges and finding the best set of VPs, which is also based on a known number of VPs for an image. EM is also a good method to refine the positions of the VPs found by other methods.

The present invention applies a modified J-Linkage method for performing vanishing point estimation step 14. While other methods may be implemented, e.g. Expectation-Maximization (EM), or RANdom SAmple Consensus” (RANSAC), J-Linkage was chosen based on two reasons: (1) J-Linkage can jointly decide all VPs in one pass. It is not an iterative method like RANSAC or EM; and (2) J-Linkage performs like an unsupervised clustering so no predefined number of VPs is required. Therefore, J-linkage is a method which can be fast and less restricted. However, the pure J-Linkage method still has its drawbacks for practical applications. In the following discussion, we first present the pure J-Linkage algorithm and address these problems.

To start from the pure J-Linkage method for VP detection, the underlying data for calculating the VPs are again the edges. Canny edge detection is first used to extract the edges. The raw edges are then preprocessed such that the edges on the same straight lines are linked first and then the intersections between edges are removed. The resultant edges are all straight and have their lengths, directions, and positions recorded. According to the definition of VPs shown in the schematic diagram of FIG. 11, we know that each VP is the common intersection of an edge group. Conversely, any two non-parallel edges can provide a guess of VP position so we can randomly choose these straight edges to generate the guesses of VP positions. A criterion is therefore needed to decide if an edge is supporting a VP. As shown in FIG. 11, we take the angle between the edge and the line connecting the VP and the center of the edge as θ. The VP is supported by the edge if θ is smaller than a predefined threshold.

We let E denote the set of N edges, and V denote the set of M hypotheses of VPs (random guesses of VPs) by the edges in E. Usually M is tens to hundreds. J-Linkage first computes the “Preference Matrix” as shown in FIG. 12. The Preference Matrix is N×M that each row represents an edge and each column is a hypothesis of VP. Each row is a “characteristic function of the preference set” where the row elements are marked ‘1’s if the corresponding VPs are supported by this edge and ‘0’s otherwise.

Although not all of the M VPs are true, the true VPs should have higher probability to be put in V, since they are the common intersections of many edges. In addition, the edges supporting the same VP should have similar ‘preference’ of VPs represented by their characteristic functions of the preference set. Hence, we can use these rows (characteristic functions) as a type of feature and group the similar edges together.

The grouping (or clustering) requires a distance metric such that we can calculate the similarity between two data. In J-Linkage, the data are the characteristic functions representing the edges; they contain binary values and are appropriate for a point-set based distance metric. Jaccard distance is such a metric which gives the following definition:

$${d}_{j} ( a , b ) = \frac{\vert a ⋃ b \vert - \vert a ⋂ b \vert}{\vert a ⋃ b \vert} \qquad Eq . 4$$

where a, b are two binary vectors of length M in our case. ∪ and ∩ are the ‘OR’ and ‘AND’ binary operators so the results are also vectors of length M. |.| is an operator to count the ‘1’ elements from the resultant vector. Jaccard distance is a true distance and between 0˜1.

We performed a bottom-up grouping that each edge itself is a cluster at the beginning. If two edges (their characteristic functions) are similar enough according to Eq. 4 (small d_j), the two edges are merged as the same cluster. Further merging will need the definition of distance between two clusters containing multiple data. It is defined as:

dⱼ(A,B)=min_{aεA,bεB}dⱼ(a,b), Eq. 5

where A, B are two data clusters.

FIG. 13 schematically illustrates Eq. 5, defining the Jaccard distance between two clusters as the distance between the two closest data points, one from each cluster. The merge continues until there is no more update of d_j (A, B)s. The resultant clusters provide a possible grouping of the edges that each group corresponds to a VP. The best VP is then selected for each group from the M VPs, which is generally based on the total lengths of supporting edges. This, along with the derivation of our VP score for selection, is discussed in further detail below.

The pure J-Linkage algorithm discussed above can jointly cluster the edges and obtain the corresponding VPs. As previously mentioned, however, J-Linkage has its drawbacks in practice. Because the generating of the M VP hypotheses is random, and the characteristic functions are fully determined by these hypotheses, it is possible to have different grouping results from different runs. If the true supporting edges dominate all edges, the distribution of the M VP locations could be stable and so could the obtained VPs. On the contrary, if the ratio of true supporting edges is smaller such as images containing many noisy edges, the random process can lead to very instable VPs which are not desired in a real system.

The VP detection problem and the stability issue may be formulated by a Bayesian framework:

V*=argmax_{V}P(V|E)∝P(E|V)P(V), Eq. 6

where V* is our objective set of VPs.

The space of V, all possible combinations of VPs, is very large. Our process to obtain the set of edges (E) is deterministic, but J-Linkage is a non-deterministic process concerning a very small subspace of V. Therefore, the effectiveness of J-Linkage is highly depending on the subspace of V that it chooses, i.e., the value of P(V).

Since the guess of V is based on E, it is possible to put some constraints, C, on E such that the guesses of V can be more reliable than the samples based on the whole E. Assuming the edges are independent from each other, we can formulate the prior probability, P(V) as:

E′={e|eεE,e satisfies C}, Eq. 7

P(V)∝Π_{eεE},p(e), Eq. 8

where p(e) is defined as the probability of edge e being a supporting edge of V.

A typical definition of C is to choose the edges according to their lengths. Long edges are indeed more reliable than short edges, however, they are not necessarily the true supporting edges. The VPD method 14 of the present invention incorporates lengths with the derived information from HoG in module 40, including the co-occurrence directions 46 and the changing blocks 48. The co-occurrence directions module 46 are calculated by the whole-image statistics, so the edges in these directions are less like noises. The changing blocks module 48 provides the possible locations of plane transitions; edges along the transition boundaries are more possible to relate to VPs while the edges inside planes may just be textures. In the method of the present invention, we define C as a fixed number of the selected edges, and the selection is based on a compound edge score calculated by edge lengths, edge directions, and changing blocks. For some edge k, we have:

$${S}_{e} ( k ) = Length ( k ) * {W}_{angle ( k )} * {W}_{block ( k )} , \\ W\_angle ( k ) = \{ \begin{matrix}2.5 , & if edge k ∈ co - occurrence directions \\ 1.0 , & elsewhere\end{matrix} , \\ W\_block ( k ) = \{ \begin{matrix}1.75 , & if edge k ∈ changing blocks \\ 0.5 , & elsewise\end{matrix} \qquad Eq . 9$$

It is assumed that p(e) in Eq. 8 is proportional to Sₑ(k). The VP detection method 28 is thus constructed as shown in FIG. 14. First at step 100, good edges are selected based on the derived information from HoG 40. Using Eq. 9, Sₑ is calculated for each edge and N′ edges are chosen as the set of E′ according to C, N′<=N.

Next at step 102, R times of J-Linkage is run to total K VP's. Using E′ to generate the hypotheses of VPs implies higher P(V) in Eq. 8, and the resultant VPs are chosen from these hypotheses. Each run may give different number of VPs and we denote the total number of VPs from the R runs as K, K<<R×N′.

Next at step 104, all the VPs from the R runs are clustered by the J-Linkage info. The R runs of J-Linkage will also help achieve the higher P(V). The K VPs from the R independent runs can have duplications or similar positions. To resolve these clustered VPs, J-Linkage may be applied again. The preference matrix for the K VPs (K×N′) is transposed as shown in FIG. 15, so each VP is represented by N′ edges. The clustering is generally very fast, as K is usually small. The number of VP clusters found is denoted as K_c, K_c<K.

Finally, at step 106, VPs are selected from outside the image to inside the image. The K_c clusters are now ready, and the best VP is selected for each VP cluster. However, K_c is still larger than the number of true VPs, because the similar wrong grouping of edges can still happen in several runs. Since K and K_c are usually very small, we search the best VP for each VP cluster as its representative from the K VPs, and then choose the best representative among all clusters. To evaluate some VP v, Eq. 10 is used to calculate a VP score:

S(v)=log(VP cluster size(v))*(Σₜ₌₁^{T}Sₑ(t)), Eq. 10

where VP cluster size(v) gives the number of VPs in the same cluster where v resides.

The VP score relates to the probability of the cluster and is effective when we are comparing the representatives between clusters. Only the supporting edges are counted for v for T edges, T<N′. If the best representative is good enough (S(v)>Sₜₕ, or the threshold value for the VP score), it is chosen as our VP, and the whole cluster is removed, as well as the supporting edges. The rest of the clusters and edges are used for choosing other VPs, until no more VP can be chosen. Moreover, the VP clusters are separated into two groups: clusters outside the image and clusters inside the image. As VPs outside the image are corresponding to most vertical and horizontal edges, we choose the outside VPs first to remove such edges, and then choose the inside ones.

In the present implementation, we set R=4, M=80˜100, N<=120, and Sₜₕ=30 (diagonal=512). CGM will only use the VPs inside the image (inside VPs).

In certain embodiments, it is desirable to validate VP's for CGM. Determination of VP ROI, described below, is specifically configured for CGM. The four plane model, also described below, may also be helpful in removal of inappropriate scenes and is also important for the vanishing direction estimation (VDE) step 16. However, for pure VP detection, it is sufficient to stop at VP ROI.

VP ROI removes the inside VPs which may lack some parts for CGM to render. FIG. 16 shows an image 110 exemplary of VP ROI in accordance with the present invention. VPs close to the left/right boundaries of the image will have very limited left/right materials for walking through. This is simple to avoid by defining an ROI as FIG. 16: the image is divided into 8×8 blocks and we only accept VPs inside the ROI of 6×6 blocks (non-shaded blocks).

If we focus on one inside VP, we can roughly describe the scene by a four-plane model: Back plane, Right plane, Left plane, Ground plane as shown in FIG. 17. The four planes are separated by four straight lines that intersect at this VP. The left image 112 of FIG. 17 illustrates a good relation between the four planes and the inside VP, and the right three examples contain inappropriate displacements of the VPs or lines for CGM (open 114, narrow right 116, and narrow left 118). We then have the following observations: (a) three angles (the arcs in image 112) are the key to the appropriate scenes, as a large opening angle can cause an inappropriate scene, and (b) the lower lines (180˜360 degrees) are particularly important.

The method 150 used to obtain the four lines separating the planes will be detailed below. At this time, we can use the inside VP and its supporting edges to calculate the directions with salient edges. These directions will be the candidates to construct the four lines separating the planes.

FIG. 18 shows a series of images to illustrate the steps to calculate the supporting directions. First, an angular histogram 122 with 360 bins (1 degree resolution) is calculated from original input image 120 by accumulating the lengths of the supporting edges. In a preferred embodiment, we accumulate the product of W_block and the edge length, because the four supporting lines are exactly the transition locations of planes so highly related to the changing blocks. Next, the reserved peak directions 124 are acquired. The directions of high peaks are preserved if they are the local maximum in the histogram. The local maximum is defined in a small window with 10-degree width, and centered at the checking direction. We call the extracted peak directions the “supporting directions,” and are shown in the dark lines of image 126. The angles 1, 2, and 3 can be used for detecting narrow left, open ground, and narrow right images. For VP validation, if two consecutive supporting directions, at least one >180 degrees, are apart more than 170 degrees, we consider this image not appropriate for CGM.

3. Vanishing Direction Estimation (VDE) and Road Width Estimation (RWE)

The vanishing direction (VD) is the central direction of the ground plane, and a viewer can keep walking on the ground plane along this direction in 3D toward the VP. The method 10 of the present invention estimates both the VD and the road width (RW) in the 2D image, so the boundaries between the vertical planes and the ground plane are needed. For VDE and RWE calculation, the inside VP and the VP validation computation results in the previous discussion are input for use.

VDE and RWE are coupled together because they both relate to the ground plane, and the two problems can be readily solved if the ground plane is already estimated. The previously detailed four-plane model, which contains the definition of the ground plane, can be used in classifying the four planes with the four supporting lines.

FIG. 19 illustrates the plane classification method 150 of the present invention, which comprises four primary stages. Plane classification method 150 starts with a superpixel segmentation step 152 wherein neighboring pixels/patches with similar colors or textures are combined as a segment. This step significantly reduces the number of data, from pixels to segments, in the following processing stages. It is appreciated that any segmenting algorithms capable of providing reasonable grouping of colors or textures may be used in place of superpixel segmentation step 152.

The next step 154 is to initialize the segments belonging to each plane. Only the segments with high confidence are assigned the plane labels, and the ambiguous segments are labeled as “undetermined,” which is classified in the next step.

The third step 156 comprises a semi-supervised classification of the unlabeled segments based on the graph-Laplacian transductive learning. The labeled segments from the previous stage and the similarities between segments are used to guide the computation.

At the final step 158, the boundary of the ground plane can be identified, since all segments are labeled. The VD is estimated first, and then an appropriate position on the line of the VD is selected to estimate the RW.

Image segmentation is used to group the neighboring pixels together based on a showing of similar colors or textures. As a result, the following plane initialization and classification will use ‘segment’ as the data unit instead of ‘pixel’. FIG. 20 shows an input image 160 and its resultant segmentation image 162 produced by superpixel segmentation method 152.

Though the superpixel method 152 already has some adaptiveness, it is still hard to use a fixed set of parameters for all images. To avoid over-segmentation for simple images, the logarithm of the number of edges is used as a rough measure of image complexity. The parameters are automatically adjusted, so simpler images tend to have larger segments. The other issue is the speed of segmentation, which is proportional to the image size. We resize images to diagonal=256 pixels for faster segmentation with satisfactory results.

The next step is to know which object/structure/region each segment belongs to. The ultimate goal of the method of the present invention is to solve for the ground plane for VDE and RWE, so the problem can be solved in a simpler way. This leads to the four-plane classification method 170 detailed in FIG. 21, which only identifies the Back plane, Right plane, Left plane, and Ground plane. As mentioned, the performance of the identified ground plane is more important than other three planes

FIG. 21 is a schematic diagram illustrating the processing flow and the data used for classification 170 of planes 190. VPD step 28 (see FIG. 14) is used to generate the inside candidate VP. The supporting directions (in the form of angular histogram 172) respective to this VP 28 with their opening angles are also validated. The candidates of the four supporting lines are these supporting directions, so the number of possible combinations of the four lines is limited. Edge image 180 is used to generate the extension from labeled segments at module 182, to classify underdetermined segments at 188.

Before executing the main processes, additional measures from the segments 174 are used. For each segment, we calculate the following things which will be used in plane initialization and classification:

(a) Intensity histogram (I): 16 bins map to 0˜255 intensity values,
(b) HoG (H): consider each segment as a block, 18 bins map to 0˜180 degrees,
(c) Angle (θ) and distance (r) between the centroid of this segment and the VP, as shown in FIG. 22.

Both I and H are normalized. For some segment i, its intensity histogram I(i) is normalized by the number of pixels in the segment such that the sum of all bins=1. Its HoG H(i), however, was normalized by the L2-norm of the bin vector as described previously.

The similarities between one segment and its neighboring segments (module 178) are also computed, which can be used to construct a similarity matrix W at 186:

$${W}_{ij} = \{ \begin{matrix}Sim ( i , j ) , & if segment i and j are neighbors \\ 0 , & otherwise\end{matrix} \qquad Eq . 11$$

where Sims(i, j) is determined by I, H, θ, and r of the two segments, and Sim(i,j)≦1.0:

Sim(i,j)=w_{HoG}·DS(H(i),H(j))+w_{HEnt}·(Ent(H(i))−Ent(H(j)))+w_{Int}·DS(I(i),I(j))+w_{Theta}·(θ(i)−θ(j))+w_{VPDist}·(r(i),−r(j)) Eq. 12

where DS (a, b) is the dissimilarity calculated by one minus the cosine coefficient of feature vectors a and b, and Ent(·) is the entropy function. w_{HoG}, w_{HEnt}, w_{Int}, w_{Theta}, and w_{VPDist} are the corresponding weights of HoG dissimilarity, HoG entropy difference, intensity dissimilarity, angle difference, and VP distance difference. W is sparse, symmetric, and with 1s at the diagonal as shown in FIG. 23. (In a preferred implementation, w_{HoG}=0.05, w_{HEnt}=0.1, w_{Int}=0.2, w_{Theta}=0.5, and w_{VPDist}=0.15).

Two assumptions were made on the input scene. First, the camera was at the upright angle when capturing the image, that is, the horizon in the image is exactly horizontal. Second, each of the 2D quadrants respective to the VP contains exactly one supporting line. (This assumption is especially important for CGM. Because the supporting lines in the 3^{rd} and 4^{th} quadrants are need for defining a good ground plane; misclassification of other three planes due to this assumption will not affect CGM results). As shown in FIG. 24, the two assumptions are close to an ideal layout of the supporting lines with sufficient materials in each plane. In addition, each supporting line will be from a restricted set of candidates, and the candidates between different supporting lines have no overlap.

The initialization of plane segments step 176 has two primary steps: (1) assign four initial lines/planes, (2) putting segments into each plane,

To assign four initial lines/planes, one supporting direction for each supporting line from the angular histogram constructed by VPD is chosen. FIG. 25 illustrates the choice of the initial supporting lines in image 122 from the angular histogram 120. The upper two supporting lines are chosen from the left block in histogram 120, while the lower two are chosen from the right block in histogram 120. As shown in FIG. 25 the back plane is usually the sky or ceiling, with much fewer edges than the right and left planes. The most conservative choices of the two upper supporting lines (1^{st} and 2^{nd} quadrants) are from the two supporting directions most close to 90°. On the contrary, the choices of the two lower supporting lines (3rd and 4th quadrants) are to preserve most areas that are possible in the ground plane; one is the smallest supporting direction larger than 180°, and the other is the largest supporting direction smaller than 360°. The two chosen lines are called the maximum ground spanning lines. With image 124, we have the very first configuration of the B, L, R planes, but not yet for the G plane, as the maximum ground spanning lines could cover too much.

Referring now to FIG. 26, identify two more lines 134 and 136, one in the 3rd and the other in the 4th quadrant, to define the most conservative ground plane. The two upper supporting lines 128 and 130 define the 1^{st} and 2^{nd} quadrants. The two more lines 134 and 136 are from the supporting directions closest to 270° which span the minimum valid ground plane. We call the two more lines 134 and 136 the minimum ground spanning lines which span the initial G plane. The area between the maximum ground spanning lines 132 and 138 and the minimum ground spanning lines 134 and 136 in the 3rd and 4th quadrants are marked Undetermined (U) as illustrated in image 126 of FIG. 26.

According to the six lines shown in FIG. 26 and the segmentation image, it is easy to identify if a segment is fully inside some plane or across the lines to other planes. The segments fully inside a plane are directly labeled.

The number of segments labeled could be very small because we set the supporting lines conservatively. This next process is to use two types of features: edge and region, to explore more segments to label. We will grow the L and R planes downward and expand the B and G planes horizontally. The extension from the labeled segments also has two steps: (1) grow from the labeled segments by vertical/horizontal edges and adjust the lines, and (2) grow from the labeled segments by regional properties.

For the growing based on edges, vertical edges are highly possible inside the L and R planes and separate the segments. (For purposes of the present application, the edges were defined with a 5 degree tolerance; that is, 85°<edge direction <95° or 265°<edge direction <275°. Similarly, the horizontal edges were defined as −5°<edge direction <5° or 175°<edge direction <185°.) Starting from the labeled L and R segments, we trace downward and check the overlap between the boundary of a U segment and the vertical edges. If the overlap is larger than a predefined VERT_TH, this U segment is changed to L or R.

However, intersections of vertical and horizontal lines can be the critical transition positions between planes, such as the lighter blocks in image 142 of FIG. 27 (which shows the detected intersection areas of the vertical and horizontal edges of original image 140) The segments attached to these intersections are labeled as U if they are between the maximum ground spanning lines, or B otherwise.

On the contrary, the growing of the B and G planes is based on the horizontal edges. FIG. 28 is an image 144 that illustrates that horizontal edges are from i) horizontal planes 148, 150 (the yellow areas, the ground, the air/ceiling, tables, . . . ), and ii) planes 146 parallel to the image plane.

Without adding more labels, B is most appropriate for representing 146 and plane 150. We again check the boundaries of the L, R, and U segments with the horizontal edges. They are updated to B if their boundary overlap>HORI_TH. The maximum ground spanning lines need to be updated after the growing because we may have more L and R segments labeled.

Growing by edges checks the boundary of a segment, and growing by region properties checks the statistics of the whole segment. Giving two thresholds, Sim_TH for Sims and H_TH for H, the B, L, and R planes can be further expanded by including the neighboring U segments if either of the following criteria is satisfied:

Sim(i,j)>Sim_{TH},segment iεB,L, or R, and segment jεU, vertical components of H(j)>H_{—}TH, segment jεU Eq. 13

In FIG. 29, the four lines in the right image 154 are the maximum ground spanning lines and the minimum ground spanning lines. We will only grow the B, L, and R planes above the segments crossing the minimum ground spanning lines. On the other hand, the G plane is also expanded to neighbor segments with high Sims. The initial segments of each plane are then constructed. Overlapping image 154 with segmentation image 152 gives us the segments crossing the lines.

Because it is hard to generate all possible cases for offline training a supervised four-plane classifier, we use a semi-supervised method which can fully use the on-line data for classification. Such a method would need some labeled data for inferring the rest, unlabeled data. In our case, the data are the segments and the labels correspond to the different planes.

We let Nₚ denote the number of labeled segments of some plane label P. They can give the rough estimations of the two probabilities:

$$\begin{matrix} The prior probability p ( P ) = \frac{1}{{N}_{p}} {\sum }_{{segment i ∈ P ,}_{∀ j}}^{ } sim ( i , j ) , \\ and & ( a ) \\ The likelihood probability p ( i \vert P ) = \frac{1}{K} {\sum }_{k = 1}^{K} sim ( i , KNN ( i , P , k ) ) , & ( b )\end{matrix}$$

where KNN(i,P,k)=j if jεP, sim(i,j) is the kth largest. (In a preferred implementation, K=3).

We roll back the labeled segments with small likelihood probabilities to U for more reliable results. Moreover, some p(i|P)'s are enforced to zero according to the angular location of segment i relative to VP: a) Right to VP, p(i|L)=0, b) Left to VP, p(i|R)=0, c) Above VP, p(i|G)=0, d) Below VP, p(i|B)=0.

The semi-supervised classification is realized by the graph—Laplacian transductive method. This method will run four times, which is equivalent to the total number of plane labels. Each run only targets at one plane label: the initialed segments belonging to this target label is considered ‘labeled’ while all other segments are considered ‘unlabeled’. The corresponding posterior probability, p(P|i) for each unlabeled segment i respective to the plane P, will be calculated at the end of each run.

For one run, we use the footnote I to represent the labeled data indexes and u to represent the unlabeled data indexes, and n is the total number of segments (data). All vectors/matrixes rearranged so the labeled data first and then the unlabeled ones. The objective is to minimize the following cost function C:

$$\begin{matrix} C = \frac{1}{2} {\sum }_{i , j = 1}^{n} {{A}_{ij} ( {y}_{i} - {y}_{j} )}^{2} \\ = \frac{1}{2} ( 2 {\sum }_{i = 1}^{n} {y}_{i}^{2} {\sum }_{j = 1}^{n} {A}_{ij} - 2 {\sum }_{j = 1}^{n} {A}_{ij} {y}_{i} {y}_{j} ) \\ = {Y}^{T} ( D - A ) Y \\ = {Y}^{T} LY ,\end{matrix} \\ Y = [ \begin{matrix}{Y}_{l} \\ {Y}_{u}\end{matrix} ] , W = [ \begin{matrix}{A}_{ll} & {A}_{l u} \\ {A}_{ul} & {A}_{uu}\end{matrix} ] , D = [ \begin{matrix}{D}_{ll} & 0 \\ 0 & {D}_{uu}\end{matrix} ] , L = [ \begin{matrix}{L}_{ll} & {L}_{lu} \\ {L}_{ul} & {L}_{uu}\end{matrix} ] , \qquad Eq . 14$$

where A is the adjacent matrix by setting the diagonal of W in Eq. 1 zero, Y={y₁, y₂, . . . , yₗ, yₗ₊₁, . . . , yₙ}^{T} is the vector of the posterior probabilities of data, i.e., the labeled data will have y=1.0. D is a diagonal matrix, Dᵢᵢ=Σⱼ₌₁ⁿAᵢⱼ and L=D−A is called the Laplacian matrix.

Since the costs between two labeled segments are fixed, we only minimize the terms associated with the unlabeled ones:

argmin_{Y}_{ᵤ}2Yᵤ^{T}LᵤₗYₗ+Yᵤ^{T}LᵤᵤYᵤ Eq. 15

It's convex so the minimum can be obtained by the derivative respective to Yᵤ:

2LᵤₗYₗ+2LᵤᵤYᵤ=0,Yᵤ=−Lᵤᵤ⁻¹LᵤₗYₗ, Eq. 16

After four runs, we get p(B|i), p(L|i), p(R|i), and p(G|i). Segment i is assigned to the label which gives the largest p(P|i),

To obtain more stable and precise results than Eq. 16, Eq. 14 can be extended with a likelihood term:

$$C = \frac{1}{2} {\sum }_{i , j = 1}^{n} {{A}_{ij} ( {y}_{i} - {y}_{j} )}^{2} \to C = \frac{1}{2} {\sum }_{i , j = 1}^{n} {{A}_{ij} ( {y}_{i} - {y}_{j} )}^{2} + λ {‖ {Y}_{u} - {S}_{u} ‖}^{2} , \qquad Eq . 17$$

where λ is a weighting scalar (0.3 in our implementation), Sᵤ is a vector containing the likelihood probabilities of the unlabeled segments belonging to this label (p(i|P)). We then have the solution:

Yᵤ=(λI+Lᵤᵤ)⁻¹(λSᵤ−LᵤₗY₁), Eq. 18

We further introduce the “Robust Multi-Class Graph Transduction” method, to apply more constraints to the transductive process. The idea is to let the resultant combination of Yᵤ and Yₗ also follow p(P)'s . We use Yᵤ from Eq. 18 as the initial value of Y_{u,0}. This method would adjusts Y_{u,0} by a function f which relates to Lᵤᵤ, Y_{u,0}, Yₗ, and p(P):

Yᵤ=Y_{u,0}−f(Lᵤᵤ,Y_{u,0},Yₗ,p(P)), Eq. 19

We finally have all segments labeled, so the estimated area of each plane can be obtained accordingly. For CGM, the most important plane is the ground plane (G) which can determine both the vanishing direction and the road width. We search the two lower spanning lines in the 3^{rd} and the 4^{th} quadrants which define the ground plane area. The two spanning lines are called the “ground spanning lines” (GSLs) and can be estimated by the following steps:

(a) Mark the boundaries between G, L, R, and B (FIG. 30A);

(b) Calculate the angle between each boundary point and the VP. Generate an angular histogram by the point counts and get the peak directions (FIG. 30B); and

(c) Estimate two spanning lines of G with the largest angular histogram responses, one between 180˜270 degrees and the other between 270˜360 degrees (FIG. 30C).

We call the angular histogram in FIG. 30B the “boundary angular histogram” and the angular histogram in image 122 of FIG. 18 the “edge angular histogram.” The similar VP validating method can again be applied to the boundary angular histogram to remove more inappropriate images from CGM. In addition, we assume the boundary of the ground plane overlays with salient edges so the ground spanning lines should match two of the supporting directions found in the edge angular histogram. That is:

∀j(j=1,2),∃is.t.|A_{edge}(i)−A_{ground}(j)|<AMatch_{—}TH, Eq. 20

where A_{edge} (·) is a supporting direction from the edge angular histogram, and A_{ground}(1) and A_{ground} (2) are the two GSLs from the ground boundary angular histogram.

A_{edge}(·)'s are from the 3rd and 4th quadrants, in between the maximum ground spanning lines and the minimum ground spanning lines. AMatch_TH is the match tolerance in angle (AMatch_TH=15 in a preferred implementation).

The VD is defined as the bisector of the angle spanned by the two GSLs. FIG. 31A and FIG. 31B illustrate an example of the VD line using the result of FIG. 30C.

Since the VD line is the bisector line of GSLs, which defines the two sides of the estimated ground plane, the corresponding points on the two sides of the road, such as points a and b in FIG. 32, will have the same distance from the VD line ( p̅a̅= p̅b̅). Conversely, giving a point p on the VD line, we can estimate the road width in 2D (in pixel) as the double of p̅a̅ ( p̅b̅). However, the constant distance of the two road sides in 3D can vary along the road in 2D which degenerates to zero at the VP. Calculating the real road width in 3D will need the full parameters of the fundamental matrix to resolve the transform. We only estimate the road width in 2D from some point on the VD line which is sufficient for CGM.

The first task is to choose the point along the VD line to calculate the road width. This depends on the criteria from applications, and in CGM we want to have full vertical materials to render both the left and the right hand sides. The full material criterion implies that we are constrained by the shorter side of materials, and the shorter side corresponds to the shorter length from the VP to the intersection between the GSL and the image boundary. For example, in the illustration 160 of FIG. 33, we will choose the left cross, which is the intersection of the left image 164 boundary and the left GSL (projected from point 162), to define the point p on the VD line.

FIG. 34 shows an illustration 170 with two example images 172 and 174 of applying the calculated VD and RW to CGM 176. The walker (model center) will be put at P on the VD line where the road width was estimated. He will be facing the VP and the model width is equal to the estimated road width. More materials on the longer side can be seen if the walker turns back horizontally or move backward in CGM.

FIG. 35 is a flow diagram that summarizes the process 200 of the present invention from SI 12, VPD 28, to VDE 18 and RWE 16. An input image would be analyzed by SI 12 first to filter at module 202 the scenes full of irregular edges and disordered directional information. The passed image is fed to our VPD based on J-Linkage 28 to calculate the inside VPs, which is followed by a VP validation at step 206 to remove more inappropriate scenes (which stop at 204). The calculated VP and its supporting edges are used to estimate the four planes at module 150 including the ground plane, which is the basis of VD estimation 18 and the road width estimation 16. CGM will require the calculated VP, VD, RW, and the center position of the model. We used FIG. 34 to explain the resultant makers on the output image:

FIG. 36 shows an image 220 that pictorially illustrates the spanning lines of the ground plane 222, vanishing point 224, score of the vanishing point 226, estimated road width 228, and vanishing direction 230.

IV. Evaluation Methods

This section details the tools module 30 illustrated in FIG. 1. The estimated VP is easy to be evaluated by the bias of the estimated VP position from its true position. There is no specific function for VP evaluation in Tools as it can be directly calculated in a spreadsheet. To evaluate the estimated VD is more challenging because it depends on both the detected VP and VD. In our method, the estimated VD is fully depending on the two ground spanning lines (GSLs) so we can reduce the problem to evaluating the two lines. Here we demonstrate the three measures designed for VD evaluation. We also provide the current evaluation results based on area bias which reflects the VDE+RWE bias best.

The most intuitive measure of the estimated GSLs is the angle bias of each line. The true position of VP (V) is the origin of the two GSLs (L₁, L₂), and we also calculate the angles of L₁ and L₂ and respective to V, θ₁ and θ₂. The angle bias ε_{θ} is defined as the sum of the absolute differences of the two line angles:

ε_{θ}=|θ₁− [symbol] |+|θ₂− [symbol] |, Eq. 21

If the estimated VDs were based on true VPs, i.e., \hat{V}=V , evaluations by angle bias are appropriate; however, if the VPs were based on previously estimated VPs, this measure cannot fully reflect the performance because the bias can be caused by both the estimated VP and VD. The VDs which are the bisectors of GSLs would also be in the same direction, but VP they point to are totally different.

If both the VP and the VD were estimated, the estimated VP can introduce a shift in location so it would be better to have a measure based on locations. We consider all image points on the estimated GSLs, and calculate the lengths of the true GSLs as |L₁| and |L₂|. For each point on the estimated GSLs, the distance between it and its corresponding true GSL can be calculated. The line position bias εₗ is defined as the sum of the point-line distances normalized by |L₁|+|L₂|:

$${ɛ}_{d} = \frac{1}{\vert {L}_{1} \vert + \vert {L}_{2} \vert} ( d ( a , {L}_{1} ) + d ( b , {L}_{2} ) ) \qquad Eq . 22$$

The third VD measure is based on the area spanned by the two GSLs. The two areas spanned by the true GSLs and the estimated GSLs are denoted as A and Â, respectively. The area bias ε_{A} is defined as the number of the different pixels between A and Â and normalized by the area of A denoted as |A|:

$${ɛ}_{A} = \frac{1}{\vert A \vert} ( {\sum }_{a ∈ \hat{A} , a ∉ A}^{ } 1 + {\sum }_{b ∈ A , b ∉ \hat{A}}^{ } 1 ) . \qquad Eq . 23$$

Here we provide the evaluation results of the current VPD+VDE+RWE algorithms based on ε_{A}. The parameters of our algorithms were kept as the default settings. We chose 42 images with clear ground boundaries and mark their GSLs as the ground truth. Since both VPD and VDE contain non-deterministic processes, we tested 5 runs of the 42 images so totally 210 instances. FIG. 37 shows the distribution of ε_{A's} of 183 instances which have their VP and VDs successfully estimated. 80% of these instances can have their biases under 50%.

FIG. 38 is a schematic diagram of a system 250 for parameter estimation of a 2D image in accordance with the present invention. The system includes a device 260 configured to receive an input image 262 and output image data 264 (e.g. parameters such as VP, RW, VD, etc.) relating to the image. The device includes a processor 252, along with application programming 256 executable on the processor 252. Application programming 256 may be stored in memory 254 and comprise one or more software modules for executing any of the methods 10, 20, 150, 170 or 200 detailed above. Device 260 may comprise a computer, camera, video recorder, mobile phone, media player, etc. capable of executing the software 256.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula (e), or computational depiction(s).

From the discussion above it will be appreciated that the invention can be embodied in various ways, including the following:

1. A method for identifying one or more image characteristics of an image, comprising: (a) inputting an image; (b) identifying edge information with respect to said image; and (c) identifying a vanishing point within said image based on said edge information.

2. A method as recited in claim 1, wherein identifying edge information comprises: (a) calculating a histogram of gradients (HoG) associated with the image; (b) determining a strength of edge information with respect to the image as a function of the calculated HoG; and (c) selecting the image for processing if the strength of the edge information meets a minimum threshold value.

3. A method as recited in claim 2, wherein the strength of the edge information is a function of an entropy value of the HoG and a ratio of short edges to total of number of edges within the image.

4. A method as recited in claim 2, wherein calculating the HoG comprises: (a) at each location of the image, calculating gradient values in vertical and horizontal directions of the image; (b) obtaining a magnitude of gradient values corresponding to each of said locations; (c) dividing the image into a plurality of blocks; and (d) calculating a histogram for each block within the plurality of blocks; (e) wherein the histogram comprises a plurality of bins each representing an orientation and accumulation of magnitudes of locations within an orientation.

5. A method as recited in claim 2, wherein identifying a vanishing point comprises: (a) determining a set of edges that occur a plurality of times in the direction of the vanishing point; and (b) applying a score to the set of edges.

6. A method as recited in claim 5, wherein the edges are scored according to one or more of the following properties: edge length, the probability that the edge belongs to a plane boundary within the image, and the probability that the edge supports a vanishing point with other edges.

7. A method as recited in claim 5, wherein each edge score is computed as a function of the calculated histogram of oriented gradients (HoG).

8. A method as recited in claim 7, wherein the vanishing point is validated for use in a 3D computer graphical model.

9. A method as recited in claim 2, further comprising classifying a plurality of planes associated with the image based on the identified vanishing point.

10. A method as recited in claim 2, wherein classifying a plurality of planes comprises: (a) segmenting the images such that neighboring pixels with similar colors or textures within the image are combined as a segment; (b) assigning segments with high confidence with one or more plane labels; (c) classifying unlabeled segments based on transductive learning; and (d) identifying a ground plane as a function of the labeled segments.

11. A method as recited in claim 2, wherein supporting edges of detected vanishing points are used to obtain candidates for a plane boundary associated with the ground plane.

12. A method as recited in claim 11, further comprising: (a) identifying a vanishing direction associated with the image based on the identified ground plane; (b) wherein the vanishing direction comprises a bisector of two boundaries associated with the ground plane.

13. A method as recited in claim 11, further comprising calculating a road width associated with the image at a location along the identified vanishing direction.

14. A system for identifying one or more image characteristics of an image, comprising: (a) a processor; and programming executable on the processor and configured for: (i) inputting an image; (ii) identifying edge information with respect to said image; and (iii) identifying a vanishing point within said image based on said edge information.

15. A system as recited in claim 1, wherein identifying edge information comprises: (a) calculating a histogram of gradients (HoG) associated with the image; (b) determining a strength of edge information with respect to the image as a function of the calculated HoG; and (c) selecting the image for processing if the strength of the edge information meets a minimum threshold value.

16. A system as recited in claim 15, wherein the strength of the edge information is a function of an entropy value of the HoG and a ratio of short edges to total of number of edges within the image.

17. A system as recited in claim 15, wherein calculating the HoG comprises: (a) at each location of the image, calculating gradient values in vertical and horizontal directions of the image; (b) obtaining a magnitude of gradient values corresponding to each of said locations; (c) dividing the image into a plurality of blocks; and (d) calculating a histogram for each block within the plurality of blocks; (e) wherein the histogram comprises a plurality of bins each representing an orientation and accumulation of magnitudes of locations within an orientation.

18. A system as recited in claim 15, wherein identifying a vanishing point comprises: (a) determining a set of edges that occur a plurality of times in the direction of the vanishing point; and (b) applying a score to the set of edges.

19. A system as recited in claim 18, wherein the edges are scored according to one or more of the following properties: edge length, the probability that the edge belongs to a plane boundary within the image, and the probability that the edge supports a vanishing point with other edges.

20. A system as recited in claim 18, wherein each edge score is computed as a function of the calculated histogram of oriented gradients (HoG).

21. A system as recited in claim 20, wherein the vanishing point is validated for use in a 3D computer graphical model.

22. A system as recited in claim 15, wherein said programming is further configured for classifying a plurality of planes associated with the image based on the identified vanishing point.

23. A system as recited in claim 15, wherein classifying a plurality of planes comprises: (a) segmenting the images such that neighboring pixels with similar colors or textures within the image are combined as a segment; (b) assigning segments with high confidence with one or more plane labels; (c) classifying unlabeled segments based on transductive learning; and (d) identifying a ground plane as a function of the labeled segments.

24. A system as recited in claim 15, wherein supporting edges of detected vanishing points are used to obtain candidates for a plane boundary associated with the ground plane.

25. A system as recited in claim 24, wherein said programming is further configured for: (a) identifying a vanishing direction associated with the image based on the identified ground plane; (b) wherein the vanishing direction comprises a bisector of two boundaries associated with the ground plane.

26. A system as recited in claim 24, wherein said programming is further configured for calculating a road width associated with the image at a location along the identified vanishing direction.

27. A system for identifying one or more image characteristics of an image, comprising: (a) a processor; and (b) programming executable on the processor and configured for: (i) inputting an image; (ii) identifying edge information with respect to said image; and (iii) identifying a vanishing point within said image based on said edge information; (iv) wherein identifying edge information comprises: calculating a histogram of gradients (HoG) associated with the image; determining a strength of edge information with respect to the image as a function of the calculated HoG; and selecting the image for processing if the strength of the edge information meets a minimum threshold value.

28. A system as recited in claim 27, wherein identifying a vanishing point comprises: (a) determining a set of edges that occur a plurality of times in the direction of the vanishing point; and (b) applying a score to the set of edges.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for identifying one or more image characteristics of an image, comprising:
(a) inputting an image;
(b) identifying edge information with respect to said image; and
(c) identifying a vanishing point within said image based on said edge information.

2. A method as recited in claim 1, wherein identifying edge information comprises:
(a) calculating a histogram of gradients (HoG) associated with the image;
(b) determining a strength of edge information with respect to the image as a function of the calculated HoG; and
(c) selecting the image for processing if the strength of the edge information meets a minimum threshold value.

3. A method as recited in claim 2, wherein the strength of the edge information is a function of an entropy value of the HoG and a ratio of short edges to total of number of edges within the image.

4. A method as recited in claim 2, wherein calculating the HoG comprises:
(a) at each location of the image, calculating gradient values in vertical and horizontal directions of the image;
(b) obtaining a magnitude of gradient values corresponding to each of said locations;
(c) dividing the image into a plurality of blocks; and
(d) calculating a histogram for each block within the plurality of blocks;
(e) wherein the histogram comprises a plurality of bins each representing an orientation and accumulation of magnitudes of locations within an orientation.

5. A method as recited in claim 2, wherein identifying a vanishing point comprises:
(a) determining a set of edges that occur a plurality of times in the direction of the vanishing point; and
(b) applying a score to the set of edges.

6. A method as recited in claim 5, wherein the edges are scored according to one or more of the following properties: edge length, the probability that the edge belongs to a plane boundary within the image, and the probability that the edge supports a vanishing point with other edges.

7. A method as recited in claim 5, wherein each edge score is computed as a function of the calculated histogram of oriented gradients (HoG).

8. A method as recited in claim 7, wherein the vanishing point is validated for use in a 3D computer graphical model.

9. A method as recited in claim 2, further comprising classifying a plurality of planes associated with the image based on the identified vanishing point.

10. A method as recited in claim 2, wherein classifying a plurality of planes comprises:
(a) segmenting the images such that neighboring pixels with similar colors or textures within the image are combined as a segment;
(b) assigning segments with high confidence with one or more plane labels;
(c) classifying unlabeled segments based on transductive learning; and
(d) identifying a ground plane as a function of the labeled segments.

11. A method as recited in claim 2, wherein supporting edges of detected vanishing points are used to obtain candidates for a plane boundary associated with the ground plane.

12. A method as recited in claim 11, further comprising:
(a) identifying a vanishing direction associated with the image based on the identified ground plane;
(b) wherein the vanishing direction comprises a bisector of two boundaries associated with the ground plane.

13. A method as recited in claim 11, further comprising calculating a road width associated with the image at a location along the identified vanishing direction.

14. A system for identifying one or more image characteristics of an image, comprising:
(a) a processor; and
programming executable on the processor and configured for:
(i) inputting an image;
(ii) identifying edge information with respect to said image; and
(iii) identifying a vanishing point within said image based on said edge information.

15. A system as recited in claim 1, wherein identifying edge information comprises:
(a) calculating a histogram of gradients (HoG) associated with the image;
(b) determining a strength of edge information with respect to the image as a function of the calculated HoG; and
(c) selecting the image for processing if the strength of the edge information meets a minimum threshold value.

16. A system as recited in claim 15, wherein the strength of the edge information is a function of an entropy value of the HoG and a ratio of short edges to total of number of edges within the image.

17. A system as recited in claim 15, wherein calculating the HoG comprises:
(a) at each location of the image, calculating gradient values in vertical and horizontal directions of the image;
(b) obtaining a magnitude of gradient values corresponding to each of said locations;
(c) dividing the image into a plurality of blocks; and
(d) calculating a histogram for each block within the plurality of blocks;
(e) wherein the histogram comprises a plurality of bins each representing an orientation and accumulation of magnitudes of locations within an orientation.

18. A system as recited in claim 15, wherein identifying a vanishing point comprises:
(a) determining a set of edges that occur a plurality of times in the direction of the vanishing point; and
(b) applying a score to the set of edges.

19. A system as recited in claim 18, wherein the edges are scored according to one or more of the following properties: edge length, the probability that the edge belongs to a plane boundary within the image, and the probability that the edge supports a vanishing point with other edges.

20. A system as recited in claim 18, wherein each edge score is computed as a function of the calculated histogram of oriented gradients (HoG).

21. A system as recited in claim 20, wherein the vanishing point is validated for use in a 3D computer graphical model.

22. A system as recited in claim 15, wherein said programming is further configured for classifying a plurality of planes associated with the image based on the identified vanishing point.

23. A system as recited in claim 15, wherein classifying a plurality of planes comprises:
(a) segmenting the images such that neighboring pixels with similar colors or textures within the image are combined as a segment;
(b) assigning segments with high confidence with one or more plane labels;
(c) classifying unlabeled segments based on transductive learning; and
(d) identifying a ground plane as a function of the labeled segments.

24. A system as recited in claim 15, wherein supporting edges of detected vanishing points are used to obtain candidates for a plane boundary associated with the ground plane.

25. A system as recited in claim 24, wherein said programming is further configured for:
(a) identifying a vanishing direction associated with the image based on the identified ground plane;
(b) wherein the vanishing direction comprises a bisector of two boundaries associated with the ground plane.

26. A system as recited in claim 24, wherein said programming is further configured for calculating a road width associated with the image at a location along the identified vanishing direction.

27. A system for identifying one or more image characteristics of an image, comprising:
(a) a processor; and
(b) programming executable on the processor and configured for:
(i) inputting an image;
(ii) identifying edge information with respect to said image; and
(iii) identifying a vanishing point within said image based on said edge information;
(iv) wherein identifying edge information comprises:
calculating a histogram of gradients (HoG) associated with the image;
determining a strength of edge information with respect to the image as a function of the calculated HoG; and
selecting the image for processing if the strength of the edge information meets a minimum threshold value.

28. A system as recited in claim 27, wherein identifying a vanishing point comprises:
(a) determining a set of edges that occur a plurality of times in the direction of the vanishing point; and
(b) applying a score to the set of edges.
